(19) United States
(12) Patent Application Publication
(10) Pub. No.: US 2025/0189084 A1
(43) Pub. Date: Jun. 12, 2025

(54) VEHICLE AIR TANK

(71) Applicant: International Truck Intellectual Property Company, LLC, Lisle, IL (US)

(72) Inventors: Stephen Richard Dann, Palatine, IL (US); Robert Douglas Charles, Saint Charles, IL (US)

(73) Assignee: International Truck Intellectual Property Company, LLC, Lisle, IL (US)

(21) Appl. No.: 18/844,437

(22) PCT Filed: Feb. 15, 2023
(86) PCT No.: PCT/US2023/013081

§ 371 Date: Sep. 6, 2024

Related U.S. Application Data
(60) Provisional application No. 63/317,621, filed on Mar. 8, 2022.

(51) Int. Cl. F17C 13/08; B60T 17/06

(52) U.S. Cl. CPC F17C 13/084; B60T 17/06; F17C 2205/0103; F17C 2221/031; F17C 2270/0171

(57) ABSTRACT

An air module (21) is disposed on a vehicle (12). The air module comprises a cradle (20) and an air tank (10). The air tank is connected with the cradle. The air module comprises is disposed adjacent an edge of a wheel well (16) and a hood (18) on the vehicle.

### REFERENCE TO RELATED APPLICATIONS

This patent application claims priority from U.S. provisional patent application Ser. No. 63/317,621 filed on Mar. 8, 2022. That provisional patent application is incorporated herein in its entirety by this reference.

### BACKGROUND

This disclosure relates generally to an air tank. More specifically, this disclosure relates to a compressed air tank mounted on a vehicle.

A currently available vehicle uses compressed air to operate, such as powering an air brake and the like. Accordingly, this vehicle may include a compressor that produces compressed air. An air tank may be pneumatically connected with the compressor to store compressed air. Such an air tank may need to be accessed periodically, such as for servicing and the like, during operation of the vehicle. Therefore, it is desirable to mount the air tank on the vehicle in a location on the vehicle that provides access to the air tank.

### SUMMARY

This disclosure includes embodiments of an air tank on a vehicle. According to one embodiment, n air tank on a vehicle comprises at least one air module disposed on the vehicle. The at least one air module comprises a cradle and an air tank. The air tank is connected with the cradle. The at least one air module comprises a first air module disposed adjacent an edge of a wheel well and a hood on the vehicle.

### DESCRIPTION OF THE DRAWINGS

FIG. 1 is a perspective view of an air tank mounted on a vehicle according to an embodiment disclosed herein;

FIG. 2 is a perspective view of an air tank mounted on a vehicle according to another embodiment disclosed herein;

FIG. 3 is a perspective view of air tanks mounted on a vehicle according to a further embodiment disclosed herein;

FIG. 4 is a top view of a vehicle with one real axle having air tanks mounted on the vehicle according to an embodiment disclosed herein;

FIG. 5 is a top view of a vehicle with two real axles having air tanks mounted on the vehicle according to an embodiment disclosed herein; and

FIG. 6 is a top view of a vehicle with three real axles having air tanks mounted on the vehicle according to an embodiment disclosed herein.

### DETAILED DESCRIPTION

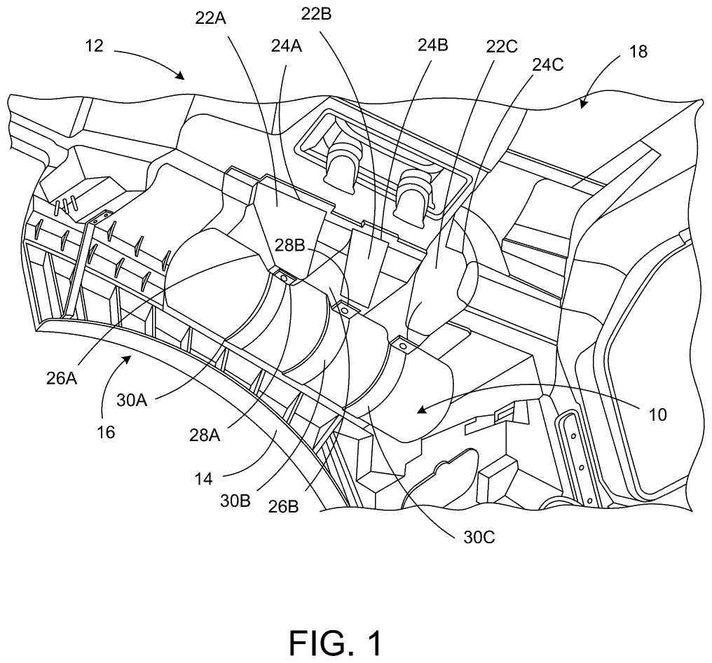

This disclosure relates to embodiments of mounting an air tank 10 on a vehicle 12, as shown in the Figures. The air tank 10 may comprise any suitable material, such as steel and the like. Focusing on FIG. 1, one embodiment of the air tank 10 is positioned adjacent an edge 14 of a wheel well 16 and a hood 18 of the vehicle 12. A cradle 20 comprising at least one member extends from the hood 18 towards the edge 14 of the wheel well 16. The air tank 10 is connected with the cradle 20. The air tank 10 and the cradle 20 comprise an air module 21. At least one air module 21 may be reproduced, sometimes with appropriate modification, such as structure attaching the at least one air module 21 to the vehicle 12 and the like, at any desirable location on the vehicle 12. In some embodiments, the cradle 20 comprises a fiberglass material, possibly reinforced, and the like. The cradle 20 may increase structural integrity, such as stiffness and the like, of the hood 18.

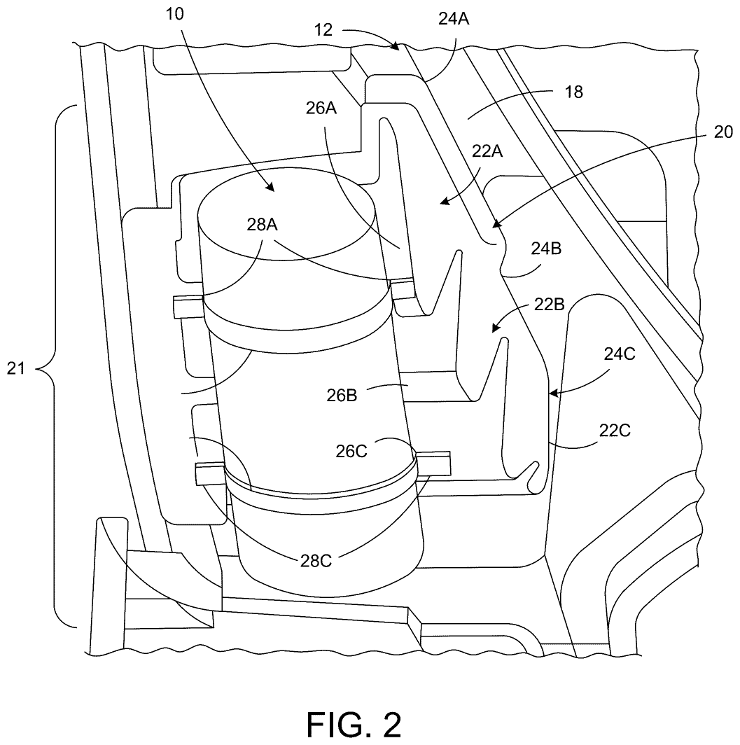

In the embodiment shown in FIG. 1, the at least one member includes a first member 22A, a second member 22B and third member 22C. Other configurations of the at least one member are possible. The first member 22A includes a first portion 24A, a second member 22B includes a first portion 24B, and third member 22C includes a first portion 24C. Each of the first portion 24A, the first portion 24B and the first portion 24C is coupled to the hood 18, such as by adhesive, a fastener and the like. Ends of each of the first member 22A, the second member 22B and the third member 22C opposite to the first portion 24A, the first portion 24B and the first portion 24C coupled to the hood 18 include a surface 26A, 26B and 26C that engage portions of the air tank 10. Configurations of the surfaces 26A, 26B and 26C correspond to matching configurations of portions of the air tank 10. For example, if the air tank 10 has a generally cylindrical shape, then the surface 26A, 26B and 26C may be radiused. Some embodiments of at least one of the first member 22A, the second member 22B and the third member 22C include at least one clip 28A, 28B and 28C disposed adjacent the surfaces 26A, 26B and 26C. At least one strap 30A, 30B and 30C is attached, such as by a fastener and the like, to the at least one clip 28A. 28B and 28C to fix the air tank 10 to the cradle 18. The embodiment shown in FIG. 2 includes the at least one strap 30A and the at least one strap 30C. The at least one strap 30A, 30B and 30C may comprise any suitable material, such as a metal and the like.

At least one suitable conduit, not shown for clarity, is pneumatically connected with the air tank 10 comprising at least one air module 21 to convey compressed air among the air tank 10 and appropriate items on the vehicle 12. These appropriate items may include, without limitation, a compressor, an air brake and other compressed air accessories on the vehicle 12. The at least one suitable conduit comprises additional elements, such a valve, a manifold, an articulated joint and the like, that allow for the hood 18 to be moved, such as between an open position, a closed position and the like, without compromising the air tank 10, the at least one suitable conduit and the like.

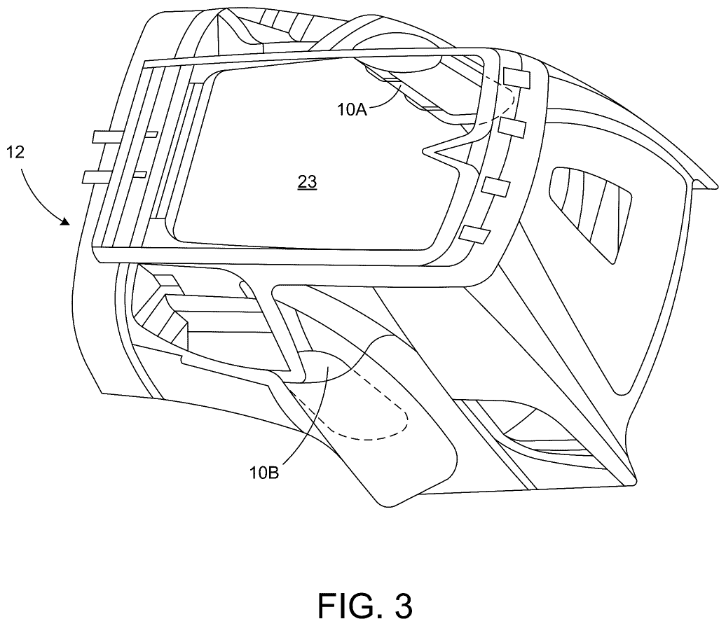

FIG. 3 shows an embodiment comprising a first air module 21 disposed on a side of the vehicle 12 adjacent the hood 18, and a second air module 21A disposed on an opposite side of the vehicle 12 adjacent the hood 18. The first air module 21 is offset from the second air module 21A by a space 23. The space 23 may be occupied by an engine on the vehicle 12.

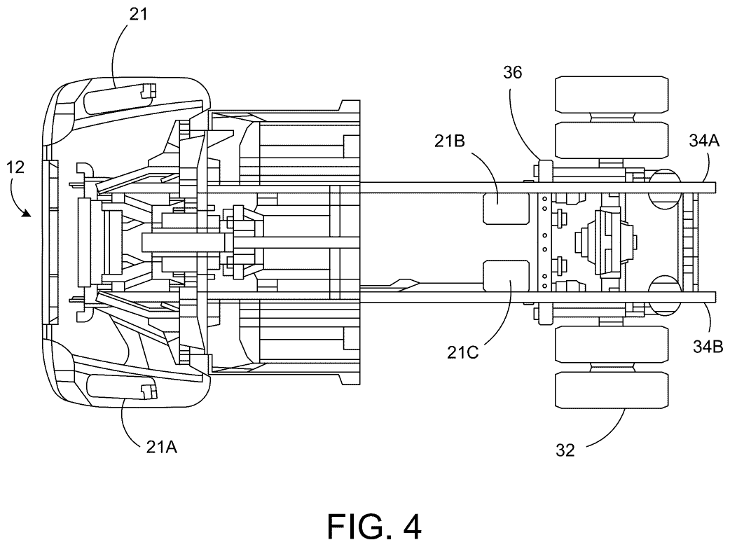

FIG. 4 shows an embodiment applied to a vehicle 12 with a rear axle 32. This embodiment is similar to the embodiment shown in FIG. 3 as this embodiment includes the first air module 21 and the second air module 21A. However, this vehicle 12 includes rails 34A and 34B that extend from the vehicle 12 beyond the rear axle 32. A cross member 36 is disposed between the rails 34A and 34B between the vehicle 12 and the rear axle 32. A third air module 21B is disposed adjacent the rail 34A and the cross member 36. A fourth air module 21C is disposed adjacent the rail 34B and the cross member 36 such that the fourth air module 21C opposes the third air module 21B. Another feature, such as a bracket and the like, may be introduced among the third air module 21b, the fourth air module 21C, the rails 34A and 34B, and the cross member 36 to facilitate mounting of the third air module 21B and the fourth air module 21C. At least one of the third air module 21B and the fourth air module 21C may supply air to an air brake operatively associated with the rear axle 32 thereby improving brake reaction timing.

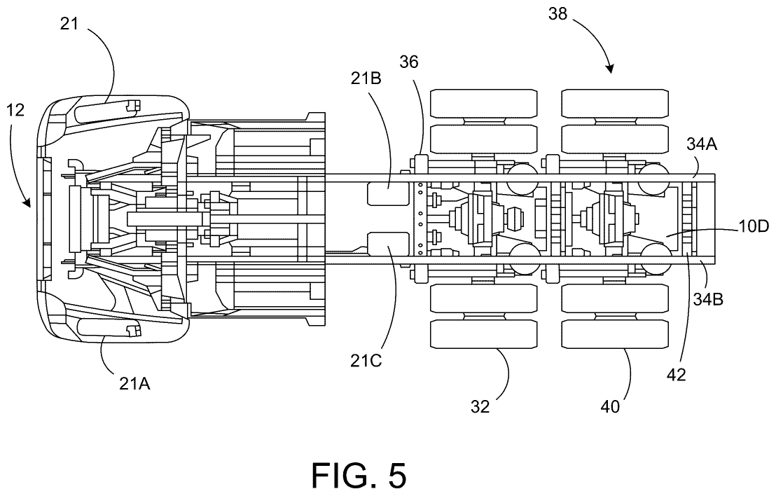

FIG. 5 shows an embodiment applied to a vehicle 12 with a tandem rear axle 38. This embodiment is substantially similar to the embodiment shown in FIG. 4. However, because the tandem rear axle 38 differs from the rear axle 32 by adding axle 40 and cross member 42 disposed behind the rear axle 32, a fifth air tank 10D is disposed between axle 40 and cross member 42 disposed between rails 34A and 34B. The fifth air tank 10D may supply air to an air brake operatively associated with the axle 40 thereby improving brake reaction timing.

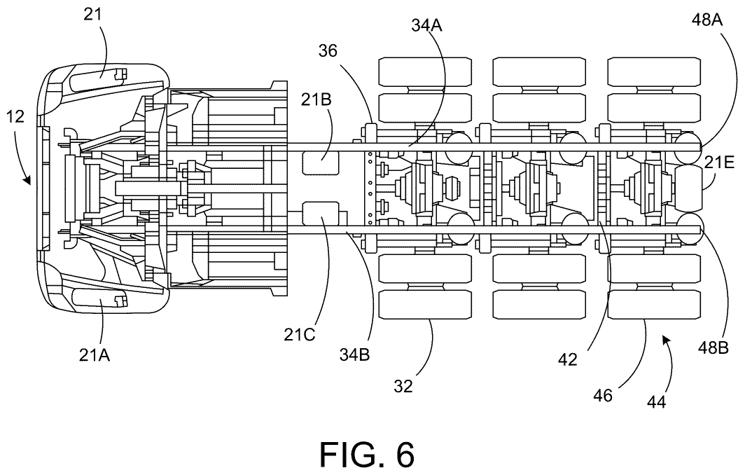

FIG. 6 shows an embodiment applied to a vehicle 12 with a tridem rear axle 44. This embodiment is substantially similar to the embodiment shown in FIG. 5. However, because the tridem rear axle 44 differs from the tandem rear axle 38 by adding axle 46 disposed behind the axle 40 and the cross member 42, a sixth air module 21E is disposed between axle 46 and ends 48A and 48B of the rails 34A and 34B. The ends 48A and 48B of the rails 34A and 34B are offset from the vehicle 12. The sixth air module 21E may supply air to an air brake operatively associated with the axle 46 thereby improving brake reaction timing.

As shown in the Figures, embodiments disclosed herein include a vehicle 12 having at least one air module comprising an air tank 10 connected with a cradle 20.

What is claimed is:

1. An air tank on a vehicle comprising:
at least one air module disposed on the vehicle, the at least one air module comprising a cradle and an air tank, the air tank being connected with the cradle;
the at least one air module comprises a first air module disposed adjacent an edge of a wheel well and a hood on the vehicle.

2. The air tank as defined in claim 1 wherein the at least one air module further comprises a second air module disposed adjacent an edge of a wheel well and a hood on the vehicle and opposite the first air module.

3. The air tank as defined in claim 2 wherein the first air module is offset from the second air module by a space.

4. The air tank as defined in claim 1 wherein the vehicle includes rails extending from the vehicle, a cross member is disposed between the rails, and the at least one air module further comprises a second air module disposed adjacent the rails and the cross member.

5. The air tank as defined in claim 1 wherein the vehicle includes rails extending from the vehicle, the rails having ends offset from the vehicle, and the at least one air module further comprises a second air module disposed adjacent the ends of the rails.
